(19) United States
(12) Patent Application Publication
(10) Pub. No.: US 2008/0030467 A1
(43) Pub. Date: Feb. 7, 2008

(54) Method And Device For Controlling Pointer On A Computer Screen By Spatial Movements Such As Head Movements

(76) Inventors: Ico Doornekamp, Barnevelde (NL); Frans Joseph Maria Rouppe van der Voort, The Hague (NL)

Correspondence Address: GORDON & REES LLP, 101 WEST BROADWAY, SUITE 1600, SAN DIEGO, CA, 92101, US

(21) Appl. No.: 11/661,790

(22) PCT Filed: Aug. 30, 2005
(86) PCT No.: PCT/NL05/00625

§ 371 Date: May 17, 2007

(30) Foreign Application Priority Data
Sep. 1, 2004 (NL) 1026945

(51) Int. Cl. G06F 3/00

(52) U.S. Cl. 345/158

(57) ABSTRACT

The invention relates to a method for controlling a pointer on a computer screen, comprising of a. providing a holder having at least two acceleration sensors which are arranged with a sensitive axis at an angle to each other on the holder and which generate acceleration signals, b. processing the acceleration signal to an x-signal and a y-signal, c. processing each signal by subtracting a pre-value, d. adjusting the pre-value repeatedly by increasing or decreasing the pre-value if the position signal is respectively greater or smaller than the pre-value for a predetermined period, and e. sending the processed position signals to a computer connected to the computer screen. The invention also relates to a device for controlling a pointer on a computer screen, comprising a holder, at least two acceleration sensors which are arranged with a sensitive axis at an angle to each other on the holder and a processing device which at least comprises integrators for acceleration signals from the acceleration sensors and a converter for converting the integrated acceleration signals into an x-signal and a y-signal, wherein the processing device further comprises a correction unit which can adjust each signal with the method according to any of the foregoing claims.

The invention relates to a method for controlling a pointer on a computer screen. The invention relates particularly to a method for controlling a pointer on a computer screen by means of head movements.

A so-called head mouse is per se known. Such a head mouse comprises at least two acceleration sensors which are arranged with the sensitive axis at an angle to each other on a holder and which generate acceleration signals. The holder is worn on the head, for instance with a headband. Acceleration signals are generated by movements of the head. The acceleration signals are processed such that an x-signal and a y-signal are obtained. The x-signal varies with head-shaking movements and the y-signal with nodding movements. These x and y-signals are fed in usual manner to a computer in order to control the pointer or “cursor”.

People whose hands are not free or who do not have full control over their hand movements can thus still control a computer pointer.

In this known head mouse the phenomenon occurs that the pointer can begin to “creep”, even when no movements are being made.

The invention now has for its object to provide a method with which this drawback can be obviated in simple and effective manner.

This object is achieved with the method according to the invention as characterized in claim 1. The pre-values to be subtracted from the position signals are adjusted repeatedly to the direction of movement prevalent for a period of time. If the position signals thus comprise a creep component, the pre-value to be subtracted will be repeatedly adjusted such that the creep component is compensated. This creep is hereby eliminated.

The method according to claim 2 is preferably applied. It has been found that a very steady and creep-free movement of the pointer is hereby obtained during normal use.

Small movements which result in agitated behaviour of the pointer on the computer screen can be eliminated by applying the method of claim 3.

A suitable frequency for sampling the position signals is about 150 hertz.

A good uniform adjustment is further achieved when the measure of claim 5 is preferably applied.

The invention further relates to a method for controlling a pointer on a computer screen as characterized in claim 6.

Normally when the user of a head mouse moves his/her head upward, the pointer on the computer screen moves upward and likewise, when the user moves his/her head to the left, the pointer on the computer screen moves to the left.

By applying the method of claim 6 the pointer moves in the opposite direction whereby, in combination with the head-worn computer screen, it appears as if the pointer is in a fixed position and the image is moved relative to the pointer. In determined applications this can provide a much more natural sensation than the usual situation.

The holder with the acceleration sensors arranged thereon and the computer screen embodied as a pair of glasses can very suitably be connected integrally to each other, i.e. embodied as a unit.

The invention further relates to a method for controlling a pointer on a computer screen which can be applied particularly to operate an apparatus provided with control buttons, such as for instance a video recorder, CD or DVD player or the like. According to the invention a representation is shown on the computer screen of the apparatus for controlling with the relevant control buttons. The user can now place the pointer on the computer screen onto the representation of the control button of the apparatus he/she wishes to operate. By then clicking in the usual manner or activating a switching member, using the computer a control signal can be generated which is fed to the apparatus to be operated.

The method of feeding this control signal to the apparatus for controlling will be self-evident to a skilled person and will not be further elucidated here. This can for instance take place with a wire connection, but it is also possible to have the computer generate a signal corresponding to the relevant signal of a wireless remote control of the apparatus.

In a suitable embodiment of the method according to the claim, the activation of the switching member, or clicking with the pointer, can take place with a speech recognition system. In this way it is possible for persons who cannot move their hands, or not move them very well, to still be able to operate appliances such as said video recorder, CD or DVD player and the like without problem.

The invention likewise relates to and provides a device for controlling a pointer on a computer screen as characterized in claim 10.

The invention will be further elucidated in the following description with reference to the accompanying figures, in which

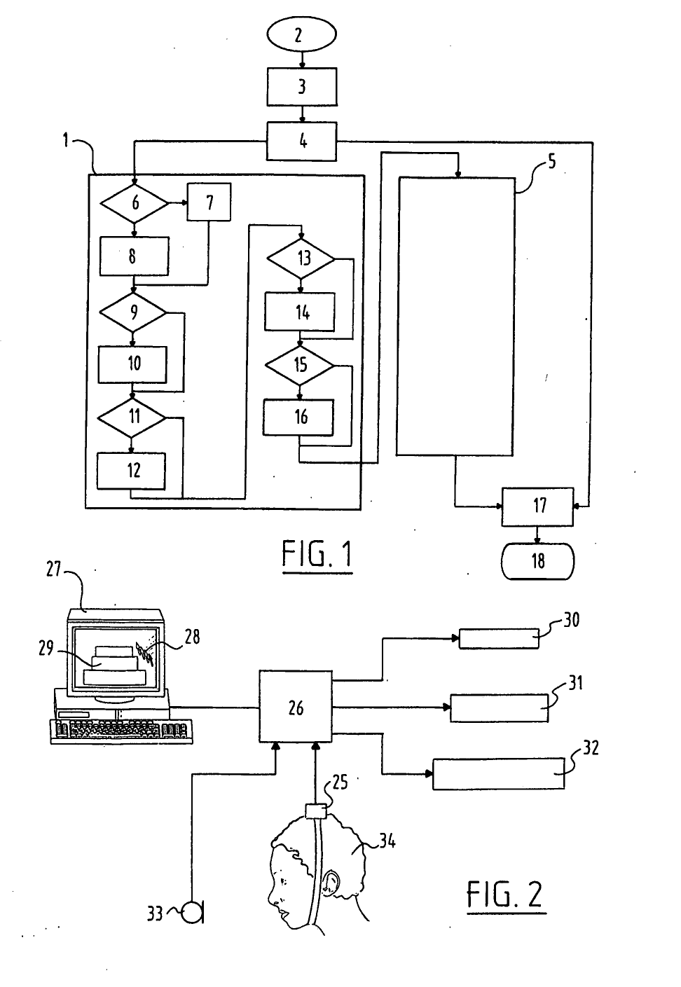

FIG. 1 shows a flow diagram of an embodiment of the method according to the invention, and

FIG. 2 shows a schematic arrangement of the method according to a preferred embodiment.

The method commences in 2, comprising of providing a holder having at least two acceleration sensors which are arranged with a sensitive axis at an angle to each other on the holder and which generate acceleration signals. These acceleration signals are processed in 3 to an x-signal and a y-signal. An activation signal from a switching member can be generated simultaneously. These x and y-signals and the activation signal are separated in 4. The activation signal is transmitted directly to 17 where it is combined with corrected x and y-signals for sending to a computer.

The x-signal is processed in block 1 as seen in FIG. 1 and the y-signal in corresponding manner in block 5. Since the processes are the same, they will only be elucidated with reference to the x-signal.

In 6 the x-signal is compared to a predetermined threshold value. If the signal is greater than this threshold value, the threshold value is subtracted from the signal in 8. If the signal is smaller than the threshold value, it is set to equal 0 in 7.

In 9 is tested whether the resulting position signal is greater than a pre-value. If this is the case, a first counter is then increased by 1 in 10. If this is not the case, 10 is then bypassed, or in other words the counter is not incremented.

In 11 is tested whether the resulting position signal is smaller than the pre-value. If this is the case, a second counter is then increased by 1 in 12. Once again in the case where this is not so, 12 is bypassed and the second counter is not incremented. In 13 is tested whether the first counter is greater than a counter value, which can for instance be 100. If this is the case, the pre-value is then increased by 1 in 14 and the first counter is set to 0. When the first counter is found in 13 not to be greater than the counter value, block 14 is bypassed and the pre-value thus remains as it was. In 15 is then tested whether the second counter has become greater than the counter value. If so, the pre-value is then decreased by 1 in 16 and the second counter is set to 0. In this case also the pre-value remains unchanged when the condition is not met.

As noted, the same operation is then performed on the y-signal. Once this has been processed, the obtained x-signals and y-signals are combined in 17 with the activation signal, and the combined signal is fed to a computer with which this step of the method is ended. This described method is repeated continuously. Making use of digital processing the signal in block 3 can be sampled for instance at a frequency of 150 hertz, and each sample can be processed in the described manner.

If creep of the pointer to the right were now to occur, i.e. in a direction in which the x value increases, the following takes place through application of the method.

When the x-signal, i.e. the increase in the intended x value, is smaller than the threshold value, this increase is set to equal 0 in 7, so that the x value remains unchanged and the position of the pointer does not change in the horizontal x direction.

Assuming however that the x-signal is greater than the threshold value, the pre-value is then subtracted from this x-signal. In a calibrated system, i.e. a system which has run through a number of the described cycles and wherein it has been possible to set the pre-value, this pre-value will be the same as the creep in x direction, whereby this creep is eliminated and the pointer remains stationary when there is no movement input.

In the case the x-signal generated as a result of the creep, i.e. the increase in the x value, is greater than the pre-value, a positive x-signal will remain with an associated creep in positive x direction.

The condition for which a test is carried out in 9 is herein fulfilled, whereby the first counter is increased by 1 in 10. When this occurs a number of times in a static situation, where there is therefore no movement input, the first counter increases to a value equal to the counter value being tested in 13. As soon as this first counter has reached the counter value, the pre-value is increased by 1 in 14. With an unchanged creep value, a pre-value of the x-signal increased by 1 will thus be subtracted in the following cycle, whereby the resulting creep movement of the pointer in the positive x direction becomes smaller. This continues until this creep in positive direction is completely eliminated. At that moment there occurs a state of balance wherein the first counter and the second counter are increased substantially alternately by 1, whereafter the pre-value is increased substantially simultaneously by 1 in 14 and decreased again by 1 in 16. The pre-value thus remains substantially constant. If the creep component were to increase or decrease in positive x direction, the pre-value will then also increase or decrease due to the described mechanism until a balance has been restored.

The same operation is carried out per cycle for the y-signal, so that a stabilization is also obtained in y direction.

It has been found that this simple correction method functions very well in practice. Only when a very gradual constant movement is made in a direction with the head will the pointer display a creep in the opposite direction after the movement has ceased. This is however quickly compensated. Such a movement moreover does not occur during normal use.

FIG. 2 shows an embodiment of the method wherein the pointer is being used to operate an appliance, such as a satellite receiver 30, a CD or DVD player 31, or for instance a video recorder 32.

A PC 26 is programmed such that it displays on the associated computer screen 27 a representation 29 of the appliance for controlling. In this case the three appliances 30, 31 and 32 are shown simultaneously and stacked together.

The representation 29 also shows representations of control buttons of appliances 30-32.

User 34 wears on his/her head the above specified holder having at least two acceleration sensors which are arranged with a sensitive axis at an angle to each other on the holder and which generate acceleration signals. These signals are transmitted indirectly to computer 26 if this latter is provided with a built-in A/D converter which converts the analog acceleration signals into digital signals. It is of course also possible to use the A/D converter as a separate unit and to feed the converted digital signals to computer 26.

In the above described manner pointer 28 is controlled on computer screen 27 by head movements. The x and y-signals are here preferably corrected in the above described manner for creep that occurs.

Cursor 20 is positioned by head movements of user 34 on the representations of control buttons of the appliances 30-32 shown with image 29. By then activating a switching member corresponding for instance with the usual left-hand button of a handheld mouse, the program running on computer 26 will send to one of the appliances 30-32 a control signal corresponding with the signal that the relevant appliance would receive through the corresponding key being pressed. This feed of control signals can take place through a wire, but it is also possible for computer 26 to be programmed such that it generates signals, for instance infrared signals, corresponding to signals from remote controls of the relevant appliances or corresponding to the relevant key being pressed.

Instead of manual activation of a switching member, the same function can be realized with a speech recognition system. Connected for this purpose to computer 26 is a microphone 33 which feeds voice signals from user 34 to computer 26, which converts these signals into the desired control signals using a per se known speech recognition program.

1. Method for controlling a pointer on a computer screen, comprising of
a. providing a holder having at least two acceleration sensors which are arranged with a sensitive axis at an angle to each other on the holder and which generate acceleration signals,
b. processing the acceleration signals to an x-signal, and a y-signal,
c. processing at least one of the signals by subtracting a pre-value,
d. adjusting the pre-value repeatedly by increasing or decreasing the pre-value if the position signal is respectively greater or smaller than the pre-value for a predetermined period, and
e. sending the processed position signals to a computer connected to the computer screen.

2. Method as claimed in claim 1, wherein the signals are digital signals which are sampled at a sampling frequency for processing purposes, the method comprising the steps of:
a. subtracting the pre-value from each sample,
b. wherein the repeated adjustment of the pre-value takes place by increasing a first counter or a second counter when the sample is respectively greater or smaller than the pre-value, and
c. increasing or decreasing the pre-value if respectively the first or the second counter reaches a predetermined counter value,
d. wherein the relevant counter is set to zero.

3. Method as claimed in any of the foregoing claims, wherein each position signal is set to equal zero if it is lower than a predetermined threshold value.

4. Method as claimed in claim 2, wherein the sampling frequency amounts to substantially 150 Hz.

5. Method as claimed in claim 4, wherein the counter value is adjustable in the range of 100 to 200.

6. Method for controlling a pointer on a computer screen, comprising the steps of:
a. providing a holder having at least two acceleration sensors which are arranged with a sensitive axis at an angle to each other on the holder and which generate acceleration signals,
b. processing the acceleration signals to an x-signal and a y-signal,
c. sending the processed signals to a computer connected to the computer screen,
d. wherein the computer screen is a screen wearable on the head as glasses and the position signals are processed such that the pointer moves in a direction opposed to that of the direction of movement of the holder.

7. Method as claimed in claim 6, wherein the computer screen is arranged on the holder.

8. Method for controlling a pointer on a computer screen, comprising the steps of:
a. providing a holder having at least two acceleration sensors which are arranged with a sensitive axis at an angle to each other on the holder and which generate acceleration signals,
b. processing the acceleration signals to an x-signal and a y-signal,
c. providing an apparatus provided with control buttons,
d. showing on the computer screen a representation of the apparatus and the control buttons,
e. sending the processed position signals to a computer connected to the computer screen for the purpose of controlling the pointer,
f. forming a control signal corresponding with operation of the control buttons by placing the pointer on the control button representation and activating a switching member, and
g. sending the control signal to the apparatus.

9. Method as claimed in claim 9, wherein the switching member is activated with a speech recognition system.

10. Device for controlling a pointer on a computer screen, comprising a holder, at least two acceleration sensors which are arranged with a sensitive axis at an angle to each other on the holder and a processing device which at least comprises integrators for acceleration signals from the acceleration sensors and a converter for converting the integrated acceleration signals into an x-signal and a y-signal, wherein the processing device further comprises a correction unit which can adjust each signal with the method as claimed in any of the foregoing claims.

11. Software to be executed on a computer for controlling a pointer on a computer screen with the aid of a holder having at least two acceleration sensors which are arranged with a sensitive axis at an angle to each other on the holder and which generate acceleration signals, the software comprising routines for:
a. processing the acceleration signals to an x-signal and a y-signal,
b. processing at least one of the signals by subtracting a pre-value,
c. adjusting the pre-value repeatedly by increasing or decreasing the pre-value if the position signal is respectively greater or smaller than the pre-value for a predetermined period, and
d. sending the processed position signals to a computer connected to the computer screen.

12. Software according to claim 11, wherein the signals are digital signals which are sampled at a sampling frequency for processing purposes, the software further comprising routines for:
a. subtracting a pre-value from each sample,
b. increasing a first counter or a second counter, to achieve repeated adjustment of the pre-value, when the sample is respectively greater or smaller than the pre-value, and
c. increasing or decreasing the pre-value if respectively the first or the second counter reaches a predetermined-counter value,
d. wherein the relevant counter is set to zero.

13. Software as claimed in any of the foregoing claims 11 and 12, further comprising a routine for setting each position signal equal to zero if it is lower than a predetermined threshold value.

14. Software as claimed in claim 12, wherein the sampling frequency amounts to substantially 150 Hz.

15. Software as claimed in claim 14, wherein the counter value is adjustable in the range of 100 to 200.

16. Software for controlling a pointer on a computer screen with the aid of a holder having at least two acceleration sensors which are arranged with a sensitive axis at an angle to each other on the holder and which generate acceleration signals, the software comprising routines for:
a. processing the acceleration signals to an x-signal and a y-signal,
b. sending the processed signals to a computer connected to the computer screen, and
c. wherein the computer screen is a screen wearable on the head as glasses and the position signals are processed such that the pointer moves in a direction opposed to chat of the direction of movement of the holder.

17. Software as claimed in claim 18, wherein the computer screen is arranged on the holder.

18. Software for controlling a pointer on a computer screen with the aid of a holder having at least two acceleration sensors which are arranged with a sensitive axis at an angle to each other on the holder and which generate acceleration signals, the software comprising routines for:
a. processing the acceleration signals to an x-signal and a y-signal,
b. accepting signals from an apparatus provided with control buttons,
c. showing on the computer screen a representation of the apparatus and the control buttons,
d. sending the processed position signals to a computer connected to the computer screen for the purpose of controlling the pointer,
e. forming a control signal corresponding with operation of the control buttons by placing the pointer on the control button representation and activating a switching member, and
f. sending the control signal to the apparatus.

19. Software as claimed in claim 18, further comprising a routine for activating the switching member with a speech recognition system.
